(19) United States
(12) Patent Application Publication
(10) Pub. No.: US 2002/0094442 A1
(43) Pub. Date: Jul. 18, 2002

(54) Bottom anti-reflection coating sandwich structure

(76) Inventor: Aaron Lee, Hsinchu (TW)

Correspondence Address: CHARLES C.H. WU & ASSOCIATES, Suite 710, 7700 IRVINE CENTER DRIVE, Irvine, CA, 92618-3043, US

(21) Appl. No.: 09/860,882

(22) Filed: May 18, 2001

(30) Foreign Application Priority Data
Jan. 12, 2001 (TW) 90100697

(51) Int. Cl. B32B 9/00

(52) U.S. Cl. 428/472; 428/698; 428/336; 428/469; 428/446

(57) ABSTRACT

A bottom anti-reflection coating sandwich structure. The sandwich structure is primarily made of a BARC, an oxygen-containing anti-reflection enforcing layer located on a conductive layer, and is located between the BARC and the oxygen-containing anti-reflection enforcing layer and used to isolate the oxygen atoms in the oxygen-containing anti-reflection enforcing layer from passing through the blocking layer of the BARC.

### CROSS-REFERENCE TO RELATED APPLICATION

This application claims the priority benefit of Taiwan application serial no. 90100697, filed on Jan. 12, 2001.

### BACKGROUND OF THE INVENTION

1. Field of the Invention

The present invention relates to a semiconductor sandwich structure. More particularly, the present invention relates to a bottom anti-reflection coating (BARC) sandwich structure.

2. Description of the Related Art

Following the reduction of the line width dimensions, the lithographic procedures are increasingly difficult. Due to reduced line width, misalignment occurs easily. Especially since the reflectivity index of the conductive layer material is usually high. As a result, the exposed light source reflects off the surface of the conductive layer during definition of the conductive layer and causes measurement error of the photoresist layer and inaccuracy of the lithographic pattern transfer. In order to prevent the above-described errors from occuring, an anti-reflection coating (ARC) is usually formed on the conductive layer. In order to reduce the reflection of the conductive layer during definition of the conductive layer, the precision of the exposed light of the photoresist is affected and thus reduces the efficiency of the device.

ARC is divided into organic material and inorganic material. Generally, organic material can be a polymer, usually forming the ARC on the photoresist layer after the photoresist layer is coated. Inorganic material can be titanium nitride, usually already formed on the conductive layer before the photoresist layer is coated, also called the BARC.

BARC is usually made of a material such as titanium nitride, which is not only anti-reflective, but can prevent the conductive layer from eroding and can be used to isolate particles. Recently, silicon oxynitride layer has been used as an enforcing layer for BARC in order to strengthen the effect of the anti-reflection.

FIG. 1 is a cross-sectional diagram illustrating a BARC sandwich structure in the related art.

Referring to FIG. 1, a titanium nitride layer 110 formed upon a metal aluminum layer 100 is used as an ARC, and a silicon oxynitride layer 120 is formed on the titanium nitride layer 110.

In the related art, silicon oxynitride is used as an ARC enforcing layer. Due to the fact that the successive procedures often require heat treatment, thus the oxygen atoms in the silicon oxynitride layer diffuse into the conductive layer via the titanium nitride layer and reacts with the conductive layer, causing the conductive layer surface to form polymers of unequal size. When performing lithographic procedure these polymers of unequal size have the same shape as a mask, causing what is called the micro-masking effect, causing measurement error in the photoresist layer and the lithographic pattern transfer to be inaccurate, thereby causing the device to have a bridge effect during operation.

### SUMMARY OF THE INVENTION

The invention provides an ARC sandwich structure and is used to isolate the oxygen atoms in the silicon oxynitride layer to pass through the titanium nitride layer and to prevent the reaction between the oxygen atoms and the conductive layer from forming a polymer.

As embodied and broadly described herein, the invention provides a BARC sandwich structure. The sandwich structure mainly formed of a BARC located upon a conductive layer, a oxygen-containing anti-reflection enforcing layer and a blocking layer located between the BARC and the oxygen-containing ARC and is used to isolate the oxygen atoms from penetrating the BARC.

The present invention uses a BARC sandwich structure in order to isolate the oxygen atoms in the oxygen-containing anti-reflection enforcing layer from penetrating into the ARC. The oxygen atoms are prevented from penetrating the BARC and cannot enter and react with the conductive layer to form a polymer. Thereafter, a micro-mask would be formed on the metal layer surface measurement error of the photoresist would occur, causing the lithographic pattern transfer to be inaccurate and causing the device to have a micro-mask effect.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention, and, together with the description, serve to explain the principles of the invention. In the drawings,

FIG. 1 is a cross-sectional diagram illustrating a BARC sandwich structure in the related art; and

FIG. 2 is a cross-sectional diagram illustrating a BARC sandwich structure according to one preferred embodiment of this invention.

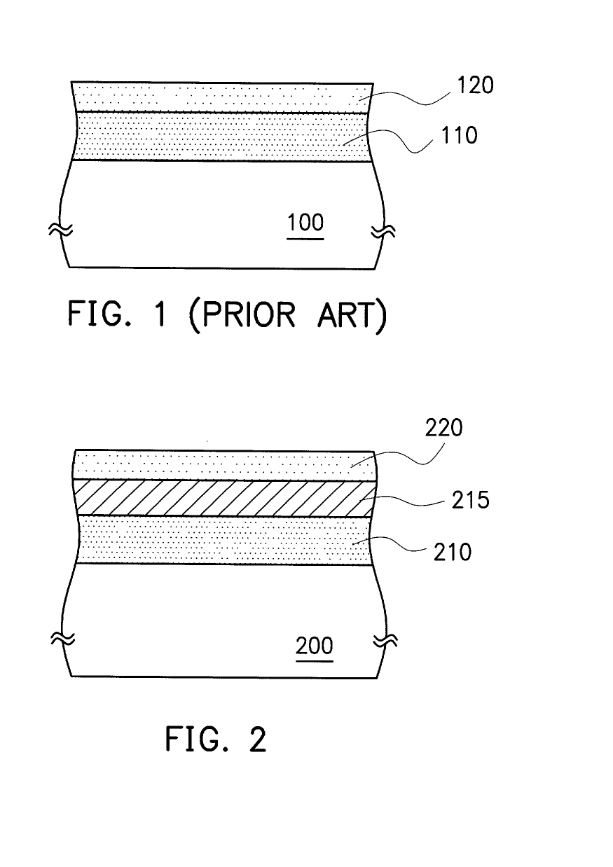

### DESCRIPTION OF THE PREFERRED EMBODIMENTS

FIG. 2 is a cross-sectional diagram illustrating a BARC sandwich structure according to one preferred embodiment of this invention.

Referring to FIG. 2, an ARC 210 is formed upon a conductive layer 200. The conductive layer 200 is made of a material such as aluminum or polysilicon. The ARC 210 is made of a material such as titanium nitride. A blocking layer 215 is formed upon the ARC 210. The blocking layer 215 is made of a material such as silicon nitride and is formed by a process such as chemical vapor deposition (CVD). An oxygen-containing anti-reflection enforcing layer 220 formed on the blocking layer 215 is used as the enforcing layer of the ARC 210, wherein the oxygen-containing anti-reflection enforcing layer 220 is made of a material such as silicon oxynitride.

The oxygen-containing anti-reflection enforcing layer 220 uses the blocking layer 215 for isolation from the ARC 210, thereby preventing the oxygen atoms in the oxygen-containing anti-reflection enforcing layer 220 from penetrating into the conductive layer 200 through the ARC 210 and forming a polymer. The thickness of the blocking layer 215 changes according to the thickness of the oxygen-containing anti-reflection enforcing layer 220. For example, when the material of the oxygen-containing anti-reflection enforcing layer 220 is silicon oxynitride and the material of the blocking layer 215 is silicon nitride, the oxygen-containing anti-reflection enforcing layer 220 has a thickness of about 300 Å, and the oxygen atoms in the oxygen-containing anti-reflection enforcing layer 220 only reaches the blocking layer 215 at a depth of about 200 Å. Since the blocking layer has a thickness of about 300 Å, the oxygen atoms can be isolated inside the ARC 210 and can be prevented from entering and forming polymers in the conductive layer 200.

The special characteristics of the present invention include two main advantages. The present invention provides a blocking layer between an oxygen-containing anti-reflection enforcing layer and is used for isolation in order to prevent the oxygen atoms in the oxygen-containing anti-reflection enforcing layer from penetrating into the conductive layer through the ARC and reacting with the conductive layer to form a polymer due to the successive heating treatment. Another advantage is that the thickness of the blocking layer provided in the present invention must be greater than the thickness of the oxygen-containing anti-reflection enforcing layer, thereby preventing the oxygen atoms in the oxygen-containing anti-reflection enforcing layer from reaching inside the ARC. The oxygen atoms are further prevented from entering and reacting with the conductive layer and forming a polymer and causing a micro-mask, which would lead the device to have problems because of bridging effect during operation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A bottom anti-reflection coating (BARC) sandwich structure, comprising:
a conductive layer;
an anti-reflection coating (ARC) located on the conductive layer;
a blocking layer located on the ARC; and
an oxygen-containing anti-reflection enforcing layer located the blocking layer.

2. The BARC sandwich structure as defined in claim 1, wherein the blocking layer is made of a material including silicon nitride.

3. The BARC sandwich structure as defined in claim 2, wherein the oxygen-containing anti-reflection enforcing layer is made of a material including silicon oxynitride.

4. The BARC sandwich structure as defined in claim 3, wherein the thickness of the blocking layer changes according to the thickness of the oxygen-containing anti-reflection enforcing layer.

5. The BARC sandwich structure as defined in claim 4, wherein the oxygen-containing anti-reflection enforcing layer has a thickness of about 300 Å.

6. The BARC sandwich structure as defined in claim 4, wherein the blocking layer has a thickness of about 300 ∈.

7. The BARC sandwich structure as defined in claim 1, wherein the BARC is made of a material including titanium nitride.

8. The BARC sandwich structure as defined in claim 1, wherein the conductive layer is made of a material including metal aluminum.

9. The BARC sandwich structure as defined in claim 1, wherein the conductive layer is made of a material such as polysilicon.

10. A BARC sandwich structure, comprising:
a conductive layer;
a first blocking layer with a first thickness located on the BARC; and
an oxygen-contain anti-reflection enforcing layer with a second thickness located on the blocking layer, wherein the first thickness is greater than the second thickness.

11. The BARC sandwich structure as defined in claim 10, wherein the blocking layer is made of a material including silicon nitride.

12. The BARC sandwich structure as defined in claim 11, wherein the oxygen-containing anti-reflection enforcing layer is made of a material including silicon oxynitride.

13. The BARC sandwich structure as defined in claim 12, wherein the oxygen-containing anti-reflection enforcing layer has a thickness of about 300 Å.

14. The BARC sandwich structure as defined in claim 13, wherein the blocking layer has a thickness of about 300 Å.

15. The BARC sandwich structure as defined in claim 10, wherein the BARC is made of a material including titanium nitride.

16. The BARC sandwich structure as defined in claim 10, wherein the conductive layer is made of a material including metal aluminum.

17. The BARC sandwich structure as defined in claim 1, wherein the conductive layer is made of a material including polysilicon.
